(19) United States
(12) Patent Application Publication
(10) Pub. No.: US 2026/0356221 A1
(43) Pub. Date: Nov. 12, 2026

(54) Device for charging a battery of an electric vehicle

(71) Applicant: SCHAEFFLER TECHNOLOGIES AG & CO. KG, Herzogenaurach (DE)

(72) Inventors: Philippe SERRECCHIA, Toulouse (FR); Jérôme LACHAIZE, Toulouse (FR)

(73) Assignee: SCHAEFFLER TECHNOLOGIES AG & CO. KG, Herzogenaurach (DE)

(21) Appl. No.: 19/139,663

(22) PCT Filed: Jan. 12, 2024
(86) PCT No.: PCT/EP2024/050648

§ 371 Date: Jun. 16, 2025

(30) Foreign Application Priority Data
Jan. 17, 2023 (FR) FR2300414

(51) Int. Cl. B60L 53/20; B60L 53/10; B60L 53/53; B60L 53/57; B60L 53/65

(52) U.S. Cl. CPC B60L 53/20; B60L 53/11; B60L 53/53; B60L 53/57; B60L 53/65; B60L 2210/10

(57) ABSTRACT

An electronic device designed to be in a first electric vehicle. The device includes a coupling device, first adaptation device, second electrical energy storage device, conversion and control device coupled to the second electrical energy storage device and to the transmission and propulsion device by way of a fifth connecting device. The conversion and control device is designed to either directly couple the second electrical energy storage device to the coupling device by way of the fifth connecting device, or couple the second electrical energy storage device to the coupling device via the first adaptation device and the rectifier.

### CROSS-REFERENCE TO RELATED APPLICATIONS

This application is the U.S. National Phase Application of PCT International Application No. PCT/EP2023/050648, filed Jan. 12, 2024, which claims priority to French Patent Application No. FR2300414, filed Jan. 17, 2023, the contents of such applications being incorporated by reference herein

### FIELD OF THE INVENTION

The invention relates to the field of electric vehicles, and more particularly to a device for charging a battery of an electric vehicle using another electric vehicle. The invention also relates to a method for controlling the charging of at least one electric vehicle battery using another electric vehicle.

### BACKGROUND OF THE INVENTION

Electric vehicles are increasingly common on our roads and are enjoying considerable popularity among motorists. However, recharging the battery of the electric vehicle is an area that hinders its development and represents a strategic challenge for motor vehicle manufacturers. Indeed, the battery recharging time, the availability and the location of the infrastructures for recharging the electric car—all these hindrances mean that the electric vehicle is still not as easy to use as a vehicle with an internal combustion engine, thereby slowing its development.

There are primarily two types of techniques or infrastructures for recharging a battery of an electric vehicle. The first involves domestic charging, connecting the electric vehicle to the single-phase domestic mains supply (220 volt domestic socket), which has the advantage of being universal but requires a relatively long recharging time.

The second involves recharging via a fast charging terminal located in a supermarket car park, for example. This type of recharging requires relatively high investment in order to be deployed, but has the advantage of allowing the battery of the electric vehicle to be charged much more quickly.

Furthermore, there are primarily two types of battery chargers for electric vehicles. The first is a battery charger in the electric vehicle, which is sometimes referred to as an “on-board charger”. This on-board charger is primarily used when connecting to the domestic mains supply and has the role of converting the voltage of said electrical system (AC voltage) into a voltage adapted for the battery of the vehicle (DC voltage).

The on-board charger has the drawback of being bulky and it further comprises a significant number of electronic voltage conversion and/or adaptation stages corresponding to the conversion of the AC voltage into the DC voltage necessary for charging the battery.

The second type of charger is a battery charger that is external to the electric vehicle and is sometimes referred to as an “off-board charger”. The external charger has the advantage of being installed on the charging terminal and not in the electric vehicle, and therefore does not occupy any space in the vehicle.

However, both the on-board charger and the external charger have the common drawback of the need for an available electrical system that is close to the electric vehicle. Indeed, for an on-board charger, it is necessary to have a domestic socket, which is connected to the electrical system, close to the electric vehicle, and for the external charger, it is necessary to have a fast charging terminal nearby. These two types of chargers therefore require a fixed energy source close to the electric vehicle in order to be able to recharge the battery.

Furthermore, the on-board charger requires a significant number of electrical conversion stages in order to make the voltage of the electrical system compatible with the voltage of the battery, generating significant conversion losses and therefore extending the charging time for the battery of the electric vehicle.

An aspect of the invention is a device for recharging an electric vehicle that does not require the presence of a fixed electrical energy source nearby and that has a lower level of conversion losses than those of the prior art.

### SUMMARY OF THE INVENTION

The invention relates to an electronic device designed to be in a first electric vehicle, the device comprising coupling means, first adaptation means coupled to the coupling means by way of second connecting means, the first adaptation means also being coupled to rectifier means by way of fourth connecting means, second electrical energy storage means designed to store electrical energy, conversion and control means coupled to the coupling means by way of third connecting means, the conversion and control means being further coupled to the second electrical energy storage means and to the transmission and propulsion means by way of fifth connecting means. The conversion and control means are designed to either directly couple the second electrical energy storage means to the coupling means by way of fifth connecting means, or couple the second electrical energy storage means to the coupling means via the first adaptation means and the rectifier means.

By virtue of the device of an aspect of the invention, it is possible to charge a battery of the first electric car using a second electric car.

For example, the second electrical energy storage means are a high-voltage, for example 800 volt, electric battery.

In one exemplary embodiment, the conversion and control means are high-power switches.

In another exemplary embodiment, the electronic device further comprises a DC/DC converter arranged between the conversion and control means and the second electrical energy storage means, making it possible to optimize conversion losses.

For example, the DC/DC converter is designed to adapt voltage levels generated by the second electrical energy storage means.

In one exemplary embodiment, the DC/DC converter is designed to galvanically isolate the second electrical energy storage means from the conversion and control means.

As a variant, the DC/DC converter is a converter having a low level of conversion losses.

In a second aspect of the invention, a method for controlling and charging a high-voltage battery of a second electric vehicle coupled to an electronic device is proposed. The method comprises the following steps:
a first step E1) consisting in coupling a second electric vehicle to said first electric vehicle by way of first connecting means of the first electric vehicle,
a second step E2) consisting in initiating a communication protocol between the second electric vehicle and the first electric vehicle to allow a donor vehicle and a recipient vehicle to be identified,
a third step E3) consisting in identifying an internal configuration of a charger of the donor vehicle, and if the recipient vehicle is designed to receive a floating continuous electric charge, then executing a fourth step E4), and if the recipient vehicle is designed to receive a referenced continuous electric charge, then executing a fifth step E5), and if the recipient vehicle is designed to receive neither a referenced continuous electric charge nor a floating continuous electric charge, executing a sixth step E6),
the fourth step E4) consisting in controlling the connection and control means of the first electric vehicle in order to short the first adaptation means and the rectifier means in order to electrically connect the second electrical energy storage means to the coupling means by way of the fifth connecting means,
the fifth step E5) consisting in controlling the conversion and control means of the first electric vehicle in order to directly couple the converter to the conversion and control means and to the second electrical energy storage means,
the sixth step E6) consisting in not activating the connection and control means of the first electric vehicle so as not to damage the electric vehicles.

For example, the conversion and control means of the first electric vehicle are controlled by way of a computer.

### BRIEF DESCRIPTION OF THE DRAWINGS

Further features and advantages of aspects of the invention will become more clearly apparent upon reading the following description. This description is purely illustrative and should be read with reference to the attached drawings, in which:

FIG. 1 is a structural illustration of an electric vehicle according to an aspect of the invention,

FIG. 2 is a structural illustration of a variant of an electric vehicle according to an aspect of the invention,

FIG. 3 shows an illustration of the method according to an aspect of the invention.

### DETAILED DESCRIPTION OF EXEMPLARY EMBODIMENTS

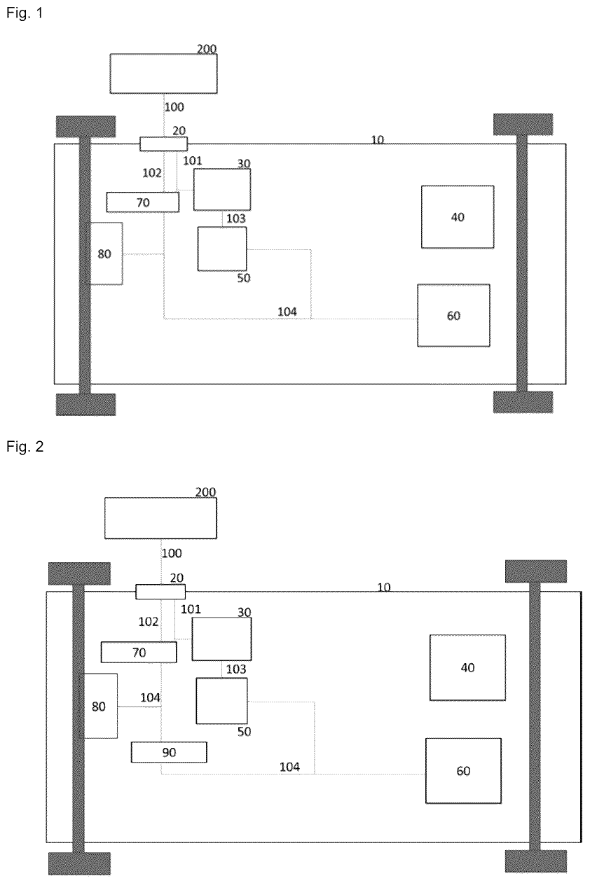

FIG. 1 shows a first electric vehicle 10 and its main functions that are well known to a person skilled in the art.

The electric vehicle 10 according to an aspect of the present invention comprises, in a general and non-limiting manner, coupling means 20 designed to couple the electric vehicle 10 to an external electrical energy source 200 by way of first connecting means 100.

For example, the external electrical energy source 200 may be a conventional power socket of a house connected to the domestic electrical system providing 220 volts AC.

As a variant, in order to avoid long-term damage to the conventional power socket of the house, the external electrical energy source 200 may be a reinforced socket that is always connected to the electrical system of the house. This reinforced socket is suitable for the flow of a higher current, allowing the recharging time to be reduced.

As a variant, the external electrical energy source 200 may be a dedicated wall-mounted charging terminal that is always located in the house. Advantageously, this wall-mounted charging terminal is specifically intended to supply electricity to the car via the mains supply of the house but designed to provide a greater electrical power in order to further reduce the recharging time.

Finally, in another exemplary use, the external electrical energy source 200 may be a fast charging terminal located in a supermarket car park. Advantageously, this type of fast charging terminal allows a high power to flow by way of a DC current, in contrast to the previous variants that are used only for an AC current. It is therefore possible to reduce the recharging time by 10 or 20.

If the external electrical energy source 200 is a conventional power socket of a house, the first connecting means 100 connecting the coupling means 20 to the external electrical energy source 200 are a universal electrical cable, which may be the one supplied with the electric vehicle 10 and designed to connect the electric vehicle 10 to the power socket of the house. This type of cable (as well as the socket) is also referred to as a mode 2 cable.

If the external electrical energy source 200 is a dedicated wall-mounted charging terminal, the first connecting means 100 may be a mode 3 electrical cable. This type of cable has a connector and a cable diameter that allow the electric vehicle 10 to be recharged more quickly.

If the external electrical energy source 200 is a public fast charging terminal, the first connecting means 100 are, for example, a dedicated mode 4 cable; in this case, said cable is that of the fast charging terminal and not that of the electric vehicle.

The electric vehicle 10 comprises first adaptation means 30 coupled to the coupling means 20 by way of second connecting means 101. The first adaptation means 30 are also coupled to rectifier means 50 by way of fourth connecting means 103.

The electric vehicle 10 also comprises first electrical energy storage means 40 and second electrical energy storage means 60. For example, the first electrical energy storage means 40 are a low-voltage battery and the second electrical energy storage means 60 are a high-voltage battery. Solutions for adapting the voltage and power level between the two batteries that allow the low-voltage battery to be recharged by the high-voltage battery are known to a person skilled in the art.

The electric vehicle 10 also comprises conversion and control means 70 coupled to the coupling means 20 by way of third connecting means 102.

The conversion and control means 70 are also coupled to the second electrical energy storage means 60 by way of fifth connecting means 104, and said conversion and control means 70 are also coupled to the transmission and propulsion means 80.

As illustrated in FIG. 1, the conversion and control means 70 are coupled in parallel with the first adaptation means 30 and the rectifier means 50. In other words, the conversion and control means 70 are designed to either directly couple the second electrical energy storage means 60 to the coupling means 20 by way of fifth connecting means 104, or couple the second electrical energy storage means 60 to the coupling means 20 via the first adaptation means 30 and the rectifier means 50.

The first electrical energy storage means 40 are, for example, a battery having an available voltage value of the order of 12 volts and designed to supply an on-board electrical system voltage for the electric vehicle 10.

The second electrical energy storage means 60 are, for example, a high-voltage electric battery. In one exemplary embodiment, the electric battery may be a 400 V or 800 V battery. The technology of the battery does not exert any influence on an aspect of the invention and therefore will not be detailed in the remainder of the description. The battery may be, for example, a lithium ion battery, a lithium metal polymer battery or a lithium ion polymer battery.

The first adaptation means 30 are, for example, an AC/DC converter.

If the electric vehicle 10 is coupled via the first connecting means 100 by way of a mode 2 or mode 3 cable, then the first adaptation means 30 and the rectifier means 50 are designed to convert an AC current provided by the electrical energy source 200 into a DC current designed to recharge the second electrical energy storage means 60.

If the electric vehicle 10 is connected to the electrical energy source 200 by way of a mode 2 or mode 3 cable, that is to say that an AC current is used, then the conversion and control means 70 are designed to manage the power supplied by the on-board charger in order to recharge the second electrical energy storage means 60. They may, for example, comprise a power computer designed to manage the compatibility of the powers between the various modules of the electric vehicle 10.

In a first exemplary embodiment, the conversion and control means 70 are designed to short the first adaptation means 30 and the rectifier means 50 in order to electrically couple the second electrical energy storage means 60 to the coupling means 20 by way of the fifth connecting means 104.

For example, the conversion and control means 70 comprise switches designed to switch high electrical power. For example, the switches may be controlled on the basis of a strategy determined by a computer. Therefore, by virtue of an aspect of the invention, it is possible to transfer the energy stored in the second electrical energy storage means 60 to the coupling means 20 in order, for example, to recharge another electric vehicle that is compatible or able to receive said energy.

In a second exemplary embodiment, as illustrated in FIG. 2, the first electric vehicle 10 comprises a DC/DC converter 90 arranged between the conversion and control means 70 and the second electrical energy storage means 60. The converter 90 is, for example, designed to adapt voltage levels of the second electrical energy storage means 60 and/or galvanically isolate the second electrical energy storage means 60 of the first electric vehicle 10 from another electric vehicle that would be coupled. The DC/DC converter 90 has a low level of conversion losses.

The connecting means 101, 102, 103 and 104 may be a DC voltage bus, which is referred to as a “DC BUS” by a person skilled in the art.

As mentioned above in the description, it is sometimes possible for an electric vehicle to encounter a situation in which its available energy reserve is too low to be able to reach the home of its driver or a public charging terminal, for example, which puts the user in a relatively difficult situation.

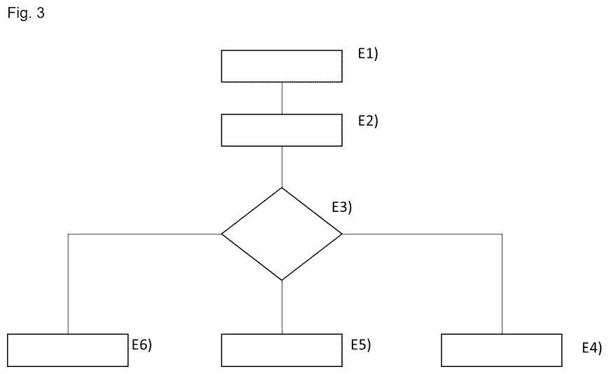

An aspect of the invention therefore proposes, as illustrated in FIG. 3, a method for controlling and charging a second electric vehicle coupled to a first electric vehicle 10 by way of the first connecting means 100 of the first electric vehicle 10. Of course, the first connecting means may be those of the other electric vehicle.

Cleverly, the method of an aspect of the invention proposes, during a first step E1), coupling a second electric vehicle to said first electric vehicle 10 by way of the first connecting means 100 of the first electric vehicle 10.

During a second step E2), the method of an aspect of the invention consists in initiating a communication protocol between the second electric vehicle and the first electric vehicle 10, which cleverly allows it to be identified which vehicle is a donor vehicle and which vehicle is the recipient vehicle.

During a third step E3), the method consists in identifying the configuration of the recipient vehicle, i.e. the second electric vehicle. Cleverly, if the second electric vehicle is designed to receive a floating continuous electric charge, the method proposes moving to a fourth step E4). Furthermore, cleverly, if the second electric vehicle is designed to receive a referenced continuous electric charge, the method also proposes moving to a fifth step E5). Finally, if the second electric vehicle is designed to receive neither a referenced continuous electric charge nor a floating continuous electric charge, the method proposes moving to a sixth step E6).

The fourth step E4) of the method consists in controlling the connection and control means 70 of the first electric vehicle in order to short the first adaptation means 30 and the rectifier means 50 in order to electrically connect the second electrical energy storage means 60 to the coupling means 20 by way of the fifth connecting means 104. Therefore, by virtue of the method of an aspect of the invention, it is possible to charge the second electric vehicle directly with minimal losses.

The fifth step E5) of the method consists in controlling the connection and control means 70 of the first electric vehicle in order to directly couple the converter 90 to the conversion and control means 70 and to the second electrical energy storage means 60, which allows galvanic isolation to be established between the second electrical energy storage means 60 and the coupling means 20, allowing the second electrical energy storage means of the second electric vehicle to be charged with minimal losses.

The sixth step E6) consists in not activating the connection and control means 70 of the first electric vehicle so as not to damage the electric vehicles.

The communication protocol during charging is not shown here because it is obvious to a person skilled in the art.

Therefore, by virtue of an aspect of the invention, it is possible to recharge the high-voltage battery of an electric vehicle coupled to another electric vehicle without the presence of a fixed energy source. Furthermore, it is possible to minimize conversion losses and therefore increase the charging capacity of the high-voltage battery.

1. An electronic device designed to be in a first electric vehicle, the device comprising coupling means, first adaptation means coupled to the coupling means by way of second connecting means, the first adaptation means also being coupled to rectifier means by way of fourth connecting means, second electrical energy storage means designed to store electrical energy, conversion and control means coupled to the coupling means by way of third connecting means, the conversion and control means being further coupled to the second electrical energy storage means and to the transmission and propulsion means by way of fifth connecting means, wherein the conversion and control means are designed to either directly couple the second electrical energy storage means to the coupling means by way of fifth connecting means, or couple the second electrical energy storage means to the coupling means via the first adaptation means and the rectifier means.

2. The electronic device as claimed in claim 1, wherein the second electrical energy storage means are a high-voltage, for example 800 volt, electric battery.

3. The electronic device as claimed in claim 1, wherein the conversion and control means are high-power switches.

4. The electronic device as claimed in claim 1, wherein the electronic device further comprises a DC/DC converter arranged between the conversion and control means and the second electrical energy storage means.

5. The electronic device as claimed in claim 4, wherein the DC/DC converter is designed to adapt voltage levels generated by the second electrical energy storage means.

6. The electronic device as claimed in claim 4, wherein the DC/DC converter is designed to galvanically isolate the second electrical energy storage means from the conversion and control means.

7. The electronic device as claimed in claim 4, wherein the DC/DC converter is a converter having a low level of conversion losses.

8. A method for controlling and charging a high-voltage battery of a second electric vehicle coupled to an electronic device as claimed in claim 1, said electronic device being arranged in a first electric vehicle, the method comprising:
a first step E1) consisting in coupling a second electric vehicle to said first electric vehicle by way of first connecting means of the first electric vehicle,
a second step E2) consisting in initiating a communication protocol between the second electric vehicle and the first electric vehicle to allow a donor vehicle and a recipient vehicle to be identified,
a third step E3) consisting in identifying an internal configuration of a charger of the donor vehicle, and if the recipient vehicle is designed to receive a floating continuous electric charge, then executing a fourth step E4), and if the recipient vehicle is designed to receive a referenced continuous electric charge, then executing a fifth step E5), and if the recipient vehicle is designed to receive neither a referenced continuous electric charge nor a floating continuous electric charge, executing a sixth step E6),
the fourth step E4) consisting in controlling the connection and control means of the first electric vehicle in order to short the first adaptation means and the rectifier means in order to electrically connect the second electrical energy storage means to the coupling means by way of the fifth connecting means,
the fifth step E5) consisting in controlling the conversion and control means of the first electric vehicle in order to directly couple the converter to the conversion and control means and to the second electrical energy storage means,
the sixth step E6) consisting in not activating the connection and control means of the first electric vehicle so as not to damage the electric vehicles.

9. The method for controlling and charging a high-voltage battery as claimed in claim 8, wherein the conversion and control means of the first electric vehicle are controlled by way of a computer.

10. The electronic device as claimed in claim 2, wherein the conversion and control means are high-power switches.
